(19) United States
(12) Patent Application Publication
(10) Pub. No.: US 2013/0199314 A1
(43) Pub. Date: Aug. 8, 2013

(54) FLYWHEEL ASSEMBLY FOR GYROSCOPIC APPLICATIONS HAVING BALL BEARING SLUG SEPARATORS

(71) Applicant: Roller Bearing Company of America, Inc., Oxford, CT (US)

(72) Inventors: Alex Habibvand, Orange, CA (US); Curtis Matthew Swartley, Surfside, CA (US)

(73) Assignee: ROLLER BEARING COMPANY OF AMERICA, INC., Oxford, CT (US)

(21) Appl. No.: 13/750,545

(22) Filed: Jan. 25, 2013

Related U.S. Application Data
(60) Provisional application No. 61/590,859, filed on Jan. 26, 2012.

(51) Int. Cl. G01C 19/16; G01C 19/06

(52) U.S. Cl. CPC G01C 19/16; G01C 19/06
USPC 74/5.95

(57) ABSTRACT

A flywheel assembly for a gyroscope includes a flywheel having a shaft extending therefrom. A top end of the shaft extends above the flywheel and a bottom end of the shaft extends below the flywheel. A top bearing is coupled to the top end of the shaft. The top bearing comprises a first inner ring, a first outer ring, and a first plurality of rolling elements disposed between the first inner ring and first outer ring. The first plurality of rolling elements is separated by a first plurality of slug ball separators. A bottom bearing is coupled to the bottom end of the shaft. The bottom bearing comprising a second inner ring, a second outer ring, and a second plurality of rolling elements disposed between the second inner ring and second outer ring. The second plurality of rolling elements is separated by a second plurality of slug ball separators.

### CROSS REFERENCE TO RELATED APPLICATION

This application claims the benefit of U.S. Provisional Patent Application No. 61/590,859, filed on Jan. 26, 2012, the contents of which are incorporated herein by reference in their entirety.

### TECHNICAL FIELD

The present invention is directed to bearings and, more particularly, angular contact bearings for use in a flywheel assembly for gyroscope applications wherein the angular contact bearings have ball bearing slug separators.

### BACKGROUND

A gyroscope is a symmetrical mass, such as a wheel, that is mounted such that it can spin about an axis in any direction and maintains an orientation during motion of, for example, a moving object or vessel. A mechanical gyroscope consists of a rapidly spinning wheel set in a framework that permits it to tilt freely in any direction or to rotate about any axis. When the gyroscope is spinning, it will resist changes in the orientation of a spin axis. For example, a spinning top resists toppling over such that the spin axis remains vertical. If a torque or twisting force is applied to the spin axis, the axis will not turn in the direction of the torque. Instead, the spin axis will move in a direction perpendicular to the applied torque. Such motion is called “precession,” which motion is the tilting or turning of the gyroscope in response to pressure. The wobbling motion of a spinning top is a simple example of precession wherein the torque that causes the wobbling is the weight of the top acting about its tapering point.

The gyroscope is a basic component of most automatic steering systems such as those used in airplanes, missiles, and unmanned aerial vehicles. The gyroscope also is used as a directional instrument used on ships because its spinning axis is unaffected by magnetic variations and therefore provides an accurate line of reference for navigation when brought in line with the north-south axis of the earth. In addition, aircraft typically are equipped with three gyroscopic instruments: the attitude indicator, the heading indicator, and the turn coordinator.

All applications of the gyroscope depend on a special form of Newton's second law, which states that a massive, rapidly spinning body rigidly resists being disturbed and tends to react to a disturbing torque by precessing (i.e., rotating slowly) in a direction at right angles to the direction of torque. A mechanical gyroscope typically includes a heavy metal wheel or rotor, universally mounted so that it has three degrees of freedom: spinning, tilting and veering. The spinning freedom provides for rotation about an axis perpendicular through the center of the gyroscope. The tilting freedom provides for rotation about a horizontal axis at right angles to the spin axis. The veering freedom provides for rotation about a vertical axis perpendicular to both of the other axes. The three degrees of freedom are obtained by mounting the rotor in two concentrically pivoted rings, an inner ring and an outer ring, known as “gimbals.” In general, the entire assembly also is known as a “gimbal system.” The gimbal system is mounted in a frame such that in a normal operating position all the axes are mutually at right angles to one another and intersect at the center of gravity of the rotor.

One conventional gyroscope includes a rotor that spins about one axis wherein the rotor is journaled to the inner gimbal. In turn, the inner gimbal is journaled to provide for oscillation in the outer gimbal. The axle of the spinning rotor defines the spin axis. The outer gimbal, which typically forms the gyroscope frame, has one degree of rotational freedom and pivots about an axis in its own plane determined by a frame support. The inner gimbal has two degrees of rotational freedom and pivots concurrently with the outer gimbal and also about an axis in its own plane that is always perpendicular to the pivotal axis of the outer gimbal. The rotor has three degrees of rotational freedom and pivots concurrently with the outer gimbal and the inner gimbal, and also spins about an axis which is always perpendicular to the axis of the inner gimbal. Alternatively, the outer gimbal may be omitted so that the rotor has only two degrees of freedom. The center of gravity of the rotor also may be offset from the axis of oscillation such that the center of gravity of the rotor and the center of suspension of the rotor may not coincide. Another conventional gyroscope, commonly referred to as a “gyrostat,” includes a rotor or flywheel mounted in a solid casing.

### SUMMARY

In one aspect, the present invention resides in a flywheel assembly for a gyroscope includes a flywheel having a shaft extending therefrom. A top end of the shaft extends above the flywheel and a bottom end of the shaft extends below the flywheel. A top bearing is coupled to the top end of the shaft. The top bearing comprises a first inner ring, a first outer ring, and a first plurality of rolling elements disposed between the first inner ring and first outer ring. The first plurality of rolling elements is separated by a first plurality of slug ball separators. A bottom bearing is coupled to the bottom end of the shaft. The bottom bearing comprising a second inner ring, a second outer ring, and a second plurality of rolling elements disposed between the second inner ring and second outer ring. The second plurality of rolling elements is separated by a second plurality of slug ball separators.

In another aspect, the present invention resides in a flywheel assembly for a gyroscope comprising a flywheel having a shaft extending therefrom. A top end of the shaft extends above the flywheel and a bottom end of the shaft extends below the flywheel. A top bearing is coupled to the top end of the shaft. The top bearing comprises a first and a second inner ring and a first and a second outer ring. A first plurality of rolling elements is positioned for rotation between the first inner ring and the first outer ring. The first plurality of rolling elements is separated by a first plurality of slug ball separators. A second plurality of rolling elements is positioned for rotation between the second inner ring and the second outer ring. The second plurality of rolling elements is separated by a second plurality of slug ball separators. A bottom bearing is coupled to the bottom end of the shaft. The bottom bearing comprising a third and a fourth inner ring and a third and a fourth outer ring. A third plurality of rolling elements is positioned for rotation between the third inner ring and the third outer ring. The third plurality of rolling elements is separated by a third plurality of slug ball separators. A fourth plurality of rolling elements is positioned for rotation between the fourth inner ring and the fourth outer ring. The fourth plurality of rolling elements is separated by a fourth plurality of slug ball separators. Each of the rolling elements of the first, second, third and fourth plurality of rolling elements defines an outer diameter D_{RE}. Each of the slug ball separators of the first, second, third and fourth plurality of slug ball separators comprises a generally cylindrical member defined by an external surface having an outer diameter D_{SB}. Each of the slug ball separators further comprises end faces located at opposing ends of the generally cylindrical member extending axially and radially inwardly therefrom to define an inner cylindrical surface having an interior diameter D_{IS}. The outer diameter D_{SB} is less than the outer diameter D_{RE}.

### BRIEF DESCRIPTION OF THE DRAWINGS

FIG. 1A is a cross-sectional view of a flywheel assembly for a gyroscope in accordance with the present invention.

FIG. 1B is a cross-sectional view of a portion of the flywheel assembly shown in FIG. 1A.

FIG. 1C is a cross-sectional view of a portion of the flywheel assembly shown in FIG. 1A.

FIG. 1D is a cross-sectional view of a portion of the flywheel assembly shown in FIG. 1C.

FIG. 2 is a cross-sectional side view of a first angular contact bearing assembly designated as a top bearing and forming part of the flywheel assembly of FIGS. 1A and 1B.

FIG. 3 is a cross-sectional view of a second angular contact bearing assembly designated as a bottom bearing forming part of the flywheel assembly of FIGS. 1A and 1C.

FIG. 4 is a perspective view of one embodiment of a slug ball separator for use in the first and second angular contact bearing assemblies of FIG. 1A.

FIG. 5A is a cross-sectional side view of the slug ball separator shown in FIG. 4.

FIG. 5B is a cross-sectional side view of another embodiment of a slug ball separator for use in the first and second angular contact bearing assemblies of FIG. 1A.

FIG. 6 is a cross-sectional view of two balls separated by the slug ball separator of FIG. 4.

FIG. 7 is a cross-sectional view of a portion of the top bearing shown in FIG. 2.

### DESCRIPTION OF THE INVENTION

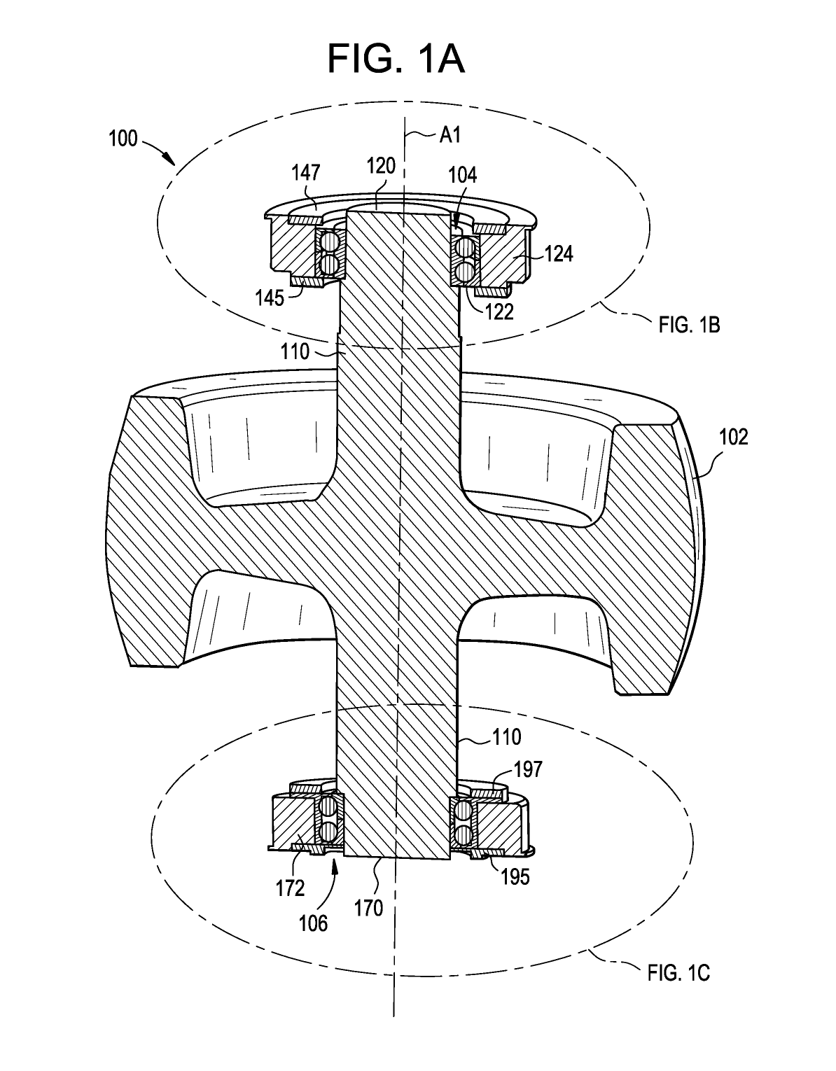

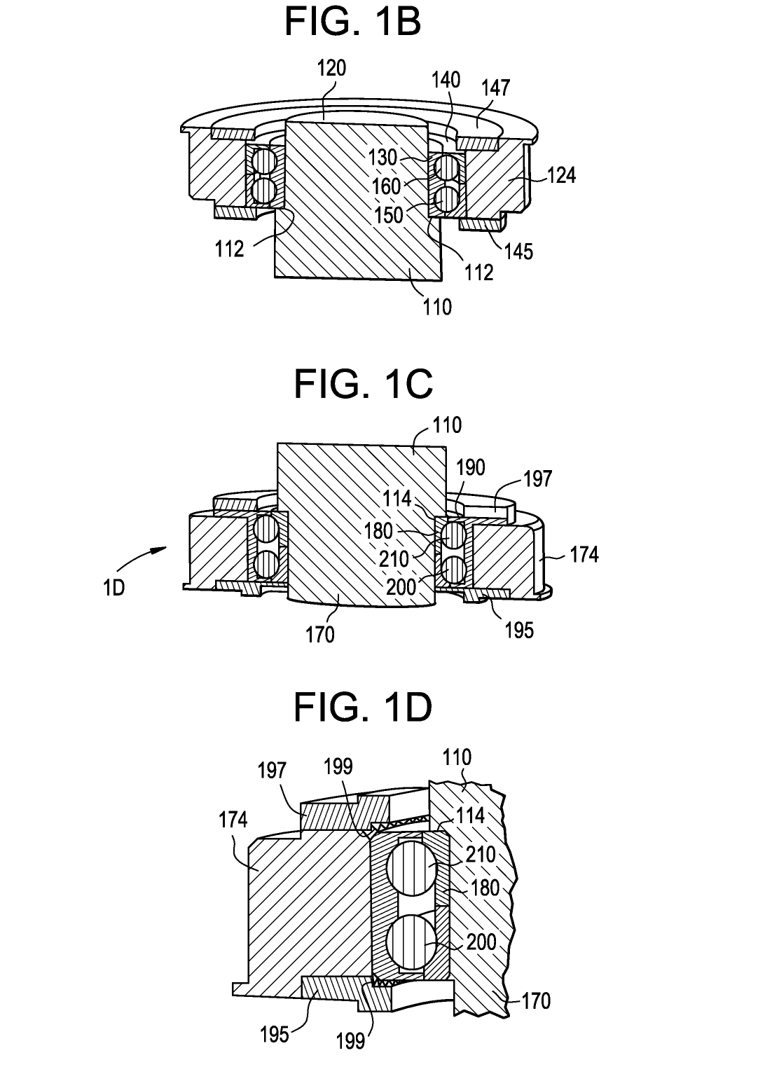

As shown in FIGS. 1A-1D, a flywheel assembly 100 for a gyroscope includes a flywheel 102 having a shaft 110 extending axially therefrom. The shaft 110 has a top end 120 extending above the flywheel 102 and a bottom end 170 extending below the flywheel 102. During operation of the assembly 100, the flywheel 102 and the shaft 110 rotate about a common axis Al. The top end 120 is coupled to a first angular contact bearing assembly 104 and is referred to herein as a top bearing 122. The bottom end 170 is coupled to a second angular contact bearing assembly 106 and is referred to herein as a bottom bearing 172. In the illustrated embodiment, the bearings 122 and 172 are coupled to the shaft 110 by an interference fit. However, the present invention is not limited in this regard as other means of coupling, such as, but not limited to mechanical fasteners can also be employed.

As further shown in FIGS. 1A-1D, the shaft 110 defines a top shoulder 112 proximate to the top end 120 of the shaft 110. The top shoulder 112 is configured to interface with at least a portion of the top bearing 122 when the top bearing 122 is coupled to the shaft 110. The shaft 110 similarly defines a bottom shoulder 114 proximate to the bottom end 170 of the shaft. The bottom shoulder 114 is configured to interface with at least a portion of the bottom bearing 172 when the bottom bearing is coupled to the shaft 110. While the shaft 110 in FIG. 1 defines a top shoulder 112 and a bottom shoulder 114, the present invention is not limited in this regard. For example, in one embodiment the shaft 110 may not include any shoulders, and the top and bottom bearings 122, 172 may interface with the shaft 110 solely through an interference fit. The top bearing 122 is disposed between a top housing 124 and the top end 120 of the shaft 110. Similarly, the bottom bearing 172 is disposed between a bottom housing 174 and the bottom end 170 of the shaft 110.

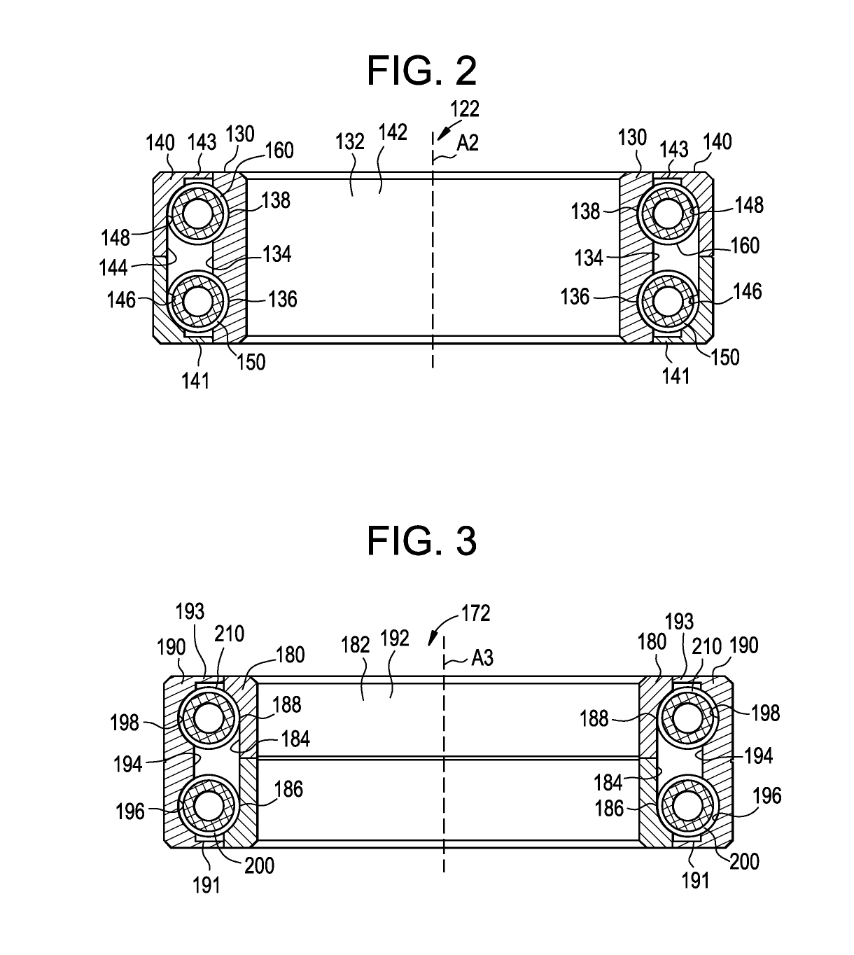

As shown in FIG. 2, the top bearing 122 includes an outer member or an outer ring 140 and an inner member or an inner ring 130 disposed within the outer ring 140. The inner ring 130 and the outer ring 140 are both generally annular and share the common central axis A2. The inner ring 130 has an annular configuration and defines a bore or a central aperture 132 for receiving the shaft 110 (not shown in FIG. 2). The inner ring 130 has an outer surface 134 that defines a first inner race 136 and a second inner race 138. The outer ring 140 has an annular configuration and defines a bore or a central aperture 142 for receiving the inner ring 130. The outer ring 140 has an inner surface 144. The inner surface 144 defines a first outer race 146 and a second outer race 148. A first plurality of rolling elements 150 is disposed between the first inner race 136 and the first outer race 146. A second plurality of rolling elements 160 is disposed between the second inner race 138 and the second outer race 148. The outer ring 140 defines integral shields 141 and 143 that extend radially inward toward the inner ring 130. The top bearing 122 is configured as a face-to-face angular contact bearing. The outer ring 140 is maintained in position by a clamping force generated by outer housing face plates 145 and 147 as shown in FIGS. 1A and 1B. In the disclosed embodiment, the first plurality of rolling elements 150 and the second plurality of rolling elements 160 comprise spherical balls.

The bottom bearing 172 is similar to the top bearing 122, with the exception that the bottom bearing 172 is configured as a back-to-back angular contact bearing. As shown in FIG. 3, the bottom bearing 172 includes an outer ring 190 and an inner ring 180 disposed within the outer ring 190. The inner ring 180 and the outer ring 190 are both generally annular and share a common central axis. The inner ring 180 has an annular configuration and defines a bore or a central aperture 182 for receiving the shaft 110. The inner ring 180 has an outer surface 184 that defines a first inner race 186 and a second inner race 188. The outer ring 190 has an annular configuration and defines a bore or a central aperture 192 for receiving the inner ring 180. The outer ring 190 has an inner surface 194. The inner surface 194 defines a first outer race 196 and a second outer race 198. A first plurality of rolling elements 200 is disposed between the first inner race 186 and the first outer race 196. A second plurality of rolling elements 210 is disposed between the second inner race 188 and the second outer race 198. The outer ring 190 defines integral shields 191 and 193 that extend radially inward toward the inner ring 180. The outer ring 190 is maintained in position by a clamping force generated by outer housing face plates 195 and 197 as shown in FIGS. 1A. 1C and 1D. One or more wave springs 199 are disposed between the outer ring 190 and outer housing face plates 195 and/or 199 to provide for an axial floating of the bearing 172 due to thermal expansion requirements. In the disclosed embodiment, the first plurality of rolling elements 200 and the second plurality of rolling elements 210 comprise spherical balls.

The rolling elements 150, 160, 200, 210 are made from any suitable material, such as metal or alloys. Suitable metals and alloys from which the rolling elements may be fabricated include, but are not limited to, stainless steels (e.g., 440C, A286, and the like), nickel-chromium-based superalloys (e.g., Inconel and the like), titanium, titanium alloys, silicon nitride, silicon carbide, zirconium, and the like. The inner ring 130 and the outer ring 140, and the inner ring 180 and the outer ring 190, are made from any suitable material, such as metal or alloys. Suitable metals from which the inner and outer rings may be fabricated include, but are not limited to, stainless steels (e.g., 17-4 PH® stainless steel), titanium, titanium alloys, and the like. The present invention is not so limited, however, as ceramics may be used in the construction of the outer race 14.

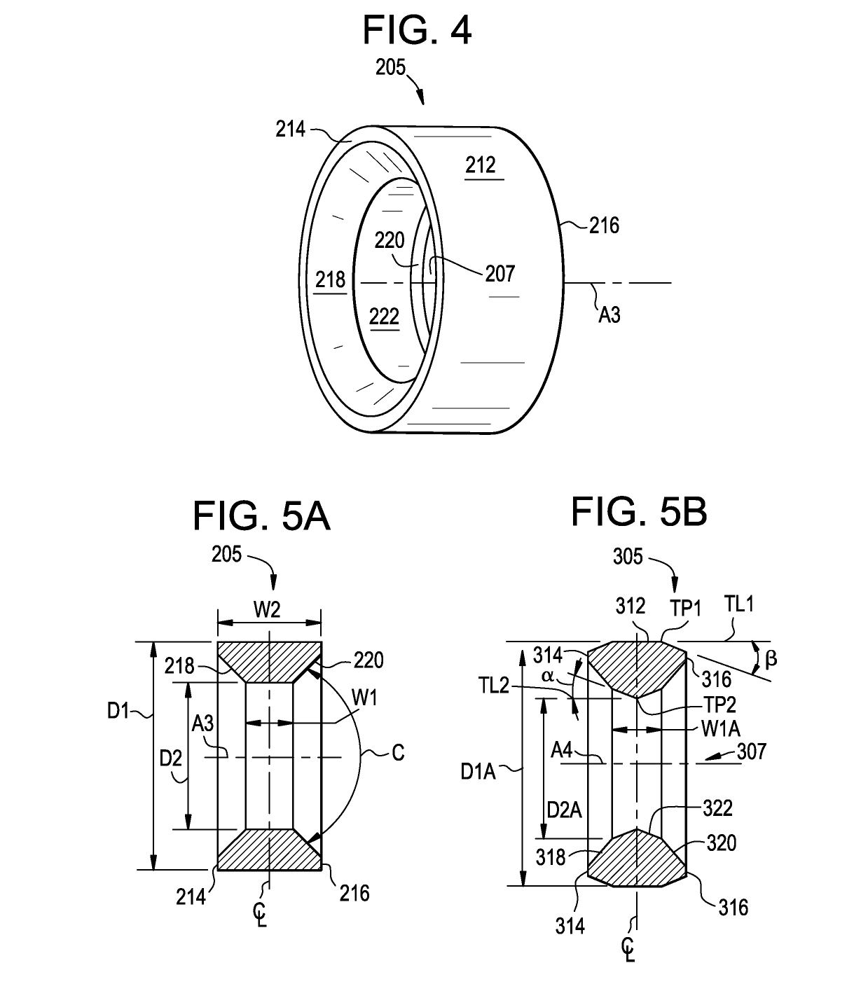

As shown in FIGS. 4-7, a plurality of slug ball separators 205 are disposed between each of the plurality of rolling elements 150, 160, 200 and 210. As shown in FIGS. 4 and 5A, the slug ball separator 205 has a generally annular configuration about a central axis A3 extending longitudinally through the slug ball separator, and defines an axial centerline CL therethrough. The slug ball separator 205 also defines a bore or a central aperture 207 therethrough. The slug ball separator 205 further has a generally cylindrical exterior surface 212 having a constant external diameter D_{OS} or D1, axial end faces 214 and 216, and conical chamfered surfaces 218 and 220 that converge from the end faces 214, 216 toward a generally cylindrical interior surface 222 having a constant internal diameter D_{IS} or D2. Chamfered surfaces 218 and 220 may conform to a conical angle C of about 75° to about 120°, for example, about 90°. Interior surface 222 extends for a distance W1 from the narrow end of the chamfered surface 218 to the narrow end of the chamfered surface 220. The slug ball separator 205 has an axial length W2 measured from end face 214 to end face 216.

A slug ball separator 305 is depicted in FIG. 5B and is similar to the slug ball separator 205 shown in FIG. 5A, thus like elements are given a like element number preceded by the numeral 3.

The slug ball separator 305 shown in FIG. 5B has a generally annular configuration about a central axis A4 extending longitudinally through the slug ball separator, and defines an axial centerline CL therethrough. The slug ball separator 305 also defines a bore or a central aperture 307 therethrough. The slug ball separator 305 further has a generally cylindrical exterior surface 312 having a varying external diameter D_{OSA} or D1A as further described below. The slug ball separator 305 further defines axial end faces 314 and 316, and conical chamfered surfaces 318 and 320 that converge from the end faces 314, 316 toward a generally cylindrical interior surface 322 having a varying internal diameter D_{ISA} or D2A as further described below. Chamfered surfaces 318 and 320 may conform to a conical angle C (not shown) of about 75° to about 120°, for example, about 90°. Interior surface 322 extends for a distance W1A from the narrow end of the chamfered surface 318 to the narrow end of the chamfered surface 320.

The exterior surface 312 of slug ball separator 305 may be contoured so that the outer diameter D1A is at a maximum between the end faces 314, 316; for example, exterior surface 312 may define an angle beta (β) of about 3° relative to a tangent line TL1 thereon that is parallel to axis A4. The exterior surface 312 further defines a tangent point TP1 thereon which is located preferably midway between the centerline CL and the end faces 314 and 316 (TP1 shown only with respect to end face 316). The varying external diameter D1A of surface 312, concentric about axis A4, thus decreases moving from the tangent point TP1 thereon toward either end face 314, 316. Similarly, the interior surface 322 may be contoured to define an angle gamma (γ) of about 3° relative to a tangent line TL2 thereon that is parallel to axis A4. The interior surface 322 further defines a tangent point TP2 thereon which is located preferably on the centerline CL of the slug ball separator 305. Accordingly, the varying inner diameter D2A of interior surface 322, concentric about axis A4, thus increases moving from the tangent point TP2 toward either end face 314, 316. The contoured surfaces provided by the angles beta (β) and gamma (γ) facilitate removal of the slug ball separator 305 from the mold in which it is formed. The angles beta (β) and gamma (γ) are shown greater than about 3° for illustration purposes only.

Slug ball separator 205 may be formed from a synthetic polymeric material such as bearing grade polyether ether ketone (PEEK), polytetrafluoroethylene (PTFE) (e.g., TEFLON™), polyimide (e.g., VESPEL™) or other similar or suitable material.

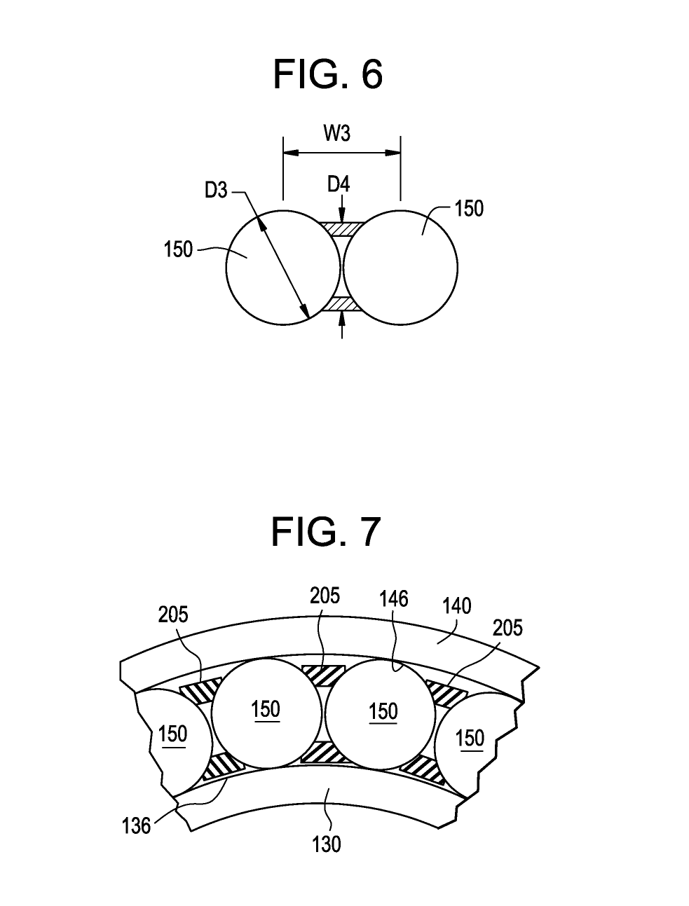

The slug ball separator 205, 305 is disposed between two like-sized balls (e.g., rolling elements 150, 160, 200 and 210) that are sized to engage the conical chamfered surfaces 218 and 220. As seen in FIG. 6, an outer diameter D_{RE} or D3 of each ball, for example one of the rolling elements 150, is larger than an outer diameter D_{SB} D4 of the slug ball separator 205. In the illustrated embodiment, the ratio of outer diameter D4 to the outer diameter D3 is about 0.85:1. In addition, the slug ball separator 205 is configured to provide a separation between the balls that is equal to about 3.2% to about 64% of the outer diameter D3 of each ball, optionally about 3.2% to about 9.6% or, in a specific example, about 6% of a ball diameter. Accordingly, in the embodiment illustrated in FIG. 6, a center-to-center separation distance W_{SEP} or W3 between a pair of adjacent rolling elements 150 in contact with, but separated by, a corresponding slug ball separator 205 is greater than the outer diameter D3; and optionally, the separation distance W3 is from about 1.02 to 1.10 times the outer diameter D3. In a specific example, the separation distance W3 is about 1.06 times the outer diameter D3.

As shown in FIG. 7, the first plurality of rolling elements 150 is disposed between the first inner race 136 and the first outer race 146 and separated from each other by slug ball separators 205. As indicated above, due to the use of slug ball separators 205, the top bearing 122 provides a surprising improvement over prior art caged ball bearing assemblies because it allows the use of a larger ball outer diameter D3. In addition, the inner and outer races, for example the first inner race 136 and the first outer race 146, are stronger than in the prior art caged ball bearing assemblies because there is no need to chamfer either race to accommodate a cage. In contrast to a caged bearing, the slug ball separators 205 orbit and flow with minimal resistance to lead-and-lag motions of the balls, for example the rolling elements 150, as the bearing 122 rotates. These advantages are achieved without impacting on bearing features such as contact angle, pitch diameter and the number of balls in the bearing.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A flywheel assembly for a gyroscope comprising:
a flywheel having a shaft extending therefrom, a top end of the shaft extending above the flywheel, and a bottom end of the shaft extending below the flywheel;
a top bearing coupled to the top end of the shaft, the top bearing comprising a first inner ring, a first outer ring, and a first plurality of rolling elements disposed between the first inner ring and the first outer ring, the first plurality of rolling elements separated by a first plurality of slug ball separators; and
a bottom bearing coupled to the bottom end of the shaft, the bottom bearing comprising a second inner ring, a second outer ring, and a second plurality of rolling elements disposed between the second inner ring and the second outer ring, the second plurality of rolling elements separated by a second plurality of slug ball separators.

2. The flywheel assembly for a gyroscope of claim 1, wherein:
the top bearing further comprises a third inner ring, a third outer ring, and a third plurality of rolling elements disposed between the third inner ring and the third outer ring, the third plurality of rolling elements separated by a third plurality of slug ball separators; and
the bottom bearing further comprises a fourth inner ring, a fourth outer ring, and a fourth plurality of rolling elements disposed between the fourth inner ring and the fourth outer ring, the fourth plurality of rolling elements separated by a fourth plurality of slug ball separators.

3. The flywheel assembly for a gyroscope of claim 1, wherein the top bearing and the bottom bearing comprise angular contact bearings.

4. The flywheel assembly for a gyroscope of claim 3, wherein the top bearing is configured as a face-to-face angular contact bearing.

5. The flywheel assembly for a gyroscope of claim 3, wherein the bottom bearing is configured as a back-to-back angular contact bearing.

6. The flywheel assembly for a gyroscope of claim 2, wherein the top bearing is configured as a face-to-face angular contact bearing and the bottom bearing is configured as a back-to-back angular contact bearing.

7. The flywheel assembly for a gyroscope of claim 1, wherein the slug ball separators comprise polyether ether ketone (PEEK).

8. A flywheel assembly for a gyroscope comprising:
a flywheel having a shaft extending therefrom, a top end of the shaft extending above the flywheel, and a bottom end of the shaft extending below the flywheel;
a top bearing coupled to the top end of the shaft, the top bearing comprising a first and a second inner ring, a first and a second outer ring, a first plurality of rolling elements positioned for rotation between the first inner ring and the first outer ring wherein the first plurality of rolling elements is separated by a first plurality of slug ball separators, and a second plurality of rolling elements positioned for rotation between the second inner ring and the second outer ring wherein the second plurality of rolling elements is separated by a second plurality of slug ball separators; and
a bottom bearing coupled to the bottom end of the shaft, the bottom bearing comprising a third and a fourth inner ring, a third and a fourth outer ring, a third plurality of rolling elements positioned for rotation between the third inner ring and the third outer ring wherein the third plurality of rolling elements is separated by a third plurality of slug ball separators, and a fourth plurality of rolling elements positioned for rotation between the fourth inner ring and the fourth outer ring wherein the fourth plurality of rolling elements is separated by a fourth plurality of slug ball separators; wherein
each of the rolling elements of the first, second, third and fourth plurality of rolling elements defines an outer diameter D_{RE}; and
each of the slug ball separators of the first, second, third and fourth plurality of slug ball separators comprises a generally cylindrical member defined by an external surface having an outer diameter D_{SB}, end faces located at opposing ends of the generally cylindrical member extending axially and radially inwardly therefrom to define an inner cylindrical surface having an interior diameter D_{IS}, the outer diameter D_{SB} being less than the outer diameter D_{RE}.

9. The flywheel assembly for a gyroscope of claim 8, wherein a ratio of the outer diameter D_{SB} to the outer diameter D_{RE} is about 0.85:1.0.

10. The flywheel assembly for a gyroscope of claim 8, wherein at least one of the outer diameter D_{SB} of the external surface and the interior diameter D_{IS} of the inner cylindrical surface defines a constant inner diameter.

11. The flywheel assembly for a gyroscope of claim 8, wherein the external surface defining the generally cylindrical member defines an angle of about 3° relative to a tangent line substantially parallel to an axis extending longitudinally through each of the slug ball separators of the first, second, third and fourth plurality of slug ball separators.

12. The flywheel assembly for a gyroscope of claim 8, wherein a separation distance W_{SEP} between a pair of adjacent rolling elements of the rolling elements of the first, second, third or fourth plurality of rolling elements in contact with, but separated by, a corresponding slug ball separator of the slug ball separators of the first, second, third or fourth plurality of slug ball separators is 205 is greater than the outer diameter D_{RE} of the rolling elements.

13. The flywheel assembly for a gyroscope of claim 12, wherein the separation distance W_{SEP} is from about 1.02 to 1.10 times the outer diameter D_{RE} of the rolling elements.

14. The flywheel assembly for a gyroscope of claim 13, wherein the separation distance W_{SEP} is about 1.06 times the outer diameter D_{RE} of the rolling elements.

15. The flywheel assembly for a gyroscope of claim 8, wherein a separation distance W_{SEP} between a pair of adjacent rolling elements of the rolling elements of the first, second, third or fourth plurality of rolling elements in contact with, but separated by, a corresponding slug ball separator of the slug ball separators of the first, second, third or fourth plurality of slug ball separators is equal to about 3.2% to about 64% of the outer diameter D_{RE} of the rolling elements.

16. The flywheel assembly for a gyroscope of claim 15, wherein the separation distance W_{SEP} is equal to about 3.2% to about 9.6% of the outer diameter D_{RE} of the rolling elements.

17. The flywheel assembly for a gyroscope of claim 16, wherein the separation distance W_{SEP} is equal to about 6% of the outer diameter D_{RE} of the rolling elements.
